(19) United States
(12) Patent Application Publication
(10) Pub. No.: US 2018/0265045 A1
(43) Pub. Date: Sep. 20, 2018

(54) ADAPTER FOR A DRIVE ARM OF A WIPING SYSTEM

(71) Applicant: Valeo Systèmes d'Essuyage, Le Mesnil Saint Denis (FR)

(72) Inventors: Philippe Billot, La Verrière (FR); Raphaël Meneguz, Shanghai (CN); Venkadesh Murugan, Chennai (IN); Balamurugan Logaian, Chennai (IN); Velayutham Sorimuthu, Chennai (IN)

(73) Assignee: Valeo Systèmes d'Essuyage, Le Mesnil Saint Denis (FR)

(21) Appl. No.: 15/780,985

(22) PCT Filed: Nov. 25, 2016
(86) PCT No.: PCT/EP2016/078780

§ 371 Date: Jun. 1, 2018

(30) Foreign Application Priority Data
Dec. 2, 2015 (FR) 1561758
Dec. 2, 2015 (FR) 1561759

(51) Int. Cl. B60S 1/40

(52) U.S. Cl. CPC B60S 1/4048; B60S 2001/4051

(57) ABSTRACT

The invention relates to an adapter (15) intended for connecting a wiper blade to an end portion (23) of a drive arm, including a first wall (16) and a second wall (19), the first wall (16) and the second wall (19) being interconnected by at least one linking wall (22), characterised in that the linking wall (22) intersects a median longitudinal plane (P2) of the adapter (15), and in that the first wall (16) has a first length (L1) which is greater than a second length (L2) of the second wall (19), the first length (L1) and the second length (L2) being measured according to straight lines parallel to the median longitudinal plane (P2), and in that the first wall (16) is provided with a means (33) for locking and/or unlocking the adapter (15) on the end portion (23).

The present invention relates to wiping systems for motor vehicles, and more particularly it relates to an adapter designed to be placed between a connector and a drive arm making up the wiping system.

A wiping system, commonly known as a wiper, for a motor vehicle is designed to remove, by wiping, the liquids and grime which may impede a driver's view of the surroundings. These wipers generally comprise a drive arm which produces a back and forth angular movement around an axis of rotation, and an elongated wiper blade having a wiping strip made of elastic material. By rubbing against a glass surface, front or rear, of the motor vehicle, the wiping strip sweeps away the water and a certain amount of the grime and evacuates this outside the field of view of the driver.

Whatever the configuration of the wiper blade, that is, whether it is a wiper blade comprising articulated stirrups which hold the wiping strip in several distinct zones, or a wiper blade comprising one or two metallic strips which hold the wiping strip along its entire length, the wiper blade is attached to the drive arm by a connection system.

In one known embodiment, an adapter able to be assembled with the connector of the wiper blade is mounted on an end portion of the drive arm. This method of connection is commonly used for wipers intended for glass surfaces situated at the front of the motor vehicle. This type of connection involves bulky forms generating too large a wind surface area.

The connection system is supposed to offer a satisfactory response to the various stresses acting on the connection system.

In the first place, it is desirable for the system of connection between the drive arm and the wiper blade to be sturdy, effective, and durable, while also being lightweight, with the least possible bulk and weight, so as not to disturb the view of the operator of the motor vehicle.

In the second place, it is desirable for the connection system to be simple and easy to implement by a user of the vehicle in order to provide nevertheless an effective link between the drive arm and the wiper blade, said link enabling for example an ergonomically easy locking and/or unlocking of the wiper blade on the drive arm.

In the third place, it is desirable for the connection system to limit the intake of air from an air flow circulating along the glass surface so as to prevent the wiper blade from lifting off from the glass surface, such a lifting being liable to disturb, if not prevent, the wiping of the glass surface.

In the fourth place, it is desirable for the connection system to have a minimum number of pieces so as to lower its production cost, the time needed to assemble the pieces, and the methods of referencing of the pieces.

The above constraints are enumerated in succession, yet they all have the same importance for the designers of wiper systems who seek the best compromise among these different constraints, which compromise is not satisfactory in the wiper systems of the prior art.

One purpose of the present invention is to propose an adapter designed to offer a better compromise among the solutions for the various constraints mentioned above.

According to a first embodiment, an adapter of the present invention is an adapter intended for connecting a wiper blade to an end portion of a drive arm. The adapter comprises a first wall and a second wall, advantageously parallel to each other. The first wall and the second wall are interconnected by at least one linking wall.

According to the present invention, the linking wall intersects a median longitudinal plane of the adapter, and the first wall has a first length which is greater than a second length of the second wall, measured along straight lines parallel to the median longitudinal plane of the adapter. The first wall, that is the higher of the two walls, is provided with at least one means of locking and/or unlocking the adapter on the end portion. This means is for example designed to be depressed by the user in order to remove the wiper blade from the drive arm.

According to a second embodiment, an adapter of the present invention is an adapter intended for connecting a wiper blade to an end portion of a drive arm, including a first wall and a second wall, interconnected by at least one linking wall, characterized in that the first wall has a first length which is greater than a second length of the second wall, the first length and the second length being measured along straight lines parallel to a median longitudinal plane of the adapter, and in that the linking wall has a curved profile, seen in cross section in a plane transverse to the median longitudinal plane.

More precisely, it will be noted that the first length and the second length may be measured along a straight line perpendicular to a plane passing through the free ends of the first and second walls, which are in particular opposite at the vertices of each wall.

It will likewise be noted that the straight lines along which the first length and the second length are measured are likewise parallel to each other.

The adapter advantageously comprises any one at least of the following characteristics, taken alone or in combination:
the first wall terminates in a first vertex, while the second wall terminates in a second vertex, the linking wall then joining the first vertex and the second vertex. It will be noted that the first vertex in particular has the same thickness as the thickness of the particular wall,
the adapter comprises at least one triangular profile, seen in a transverse plane. Said profile is recognizable by observing the adapter in a longitudinal direction. This triangular profile may be formed by the external faces of the adapter and/or by internal faces of this adapter,
the linking wall comprises an external face which is convex, seen from a position located between the first wall and the second wall. Alternatively, the curved profile is convex as seen from a position situated between the first wall and the second wall,
the radius of curvature of the external convex face is between 5 mm and 100 mm, preferably between 7 mm and 30 mm, and for example equal to 17.7 mm. Alternatively, the curved profile of the linking wall runs along a radius of curvature between 5 mm and 100 mm, preferably between 7 mm and 30 mm, and for example 17.7 mm. Said radii define respectively a virtual circle in whose periphery is inscribed the curvature of the external face,
the radius of curvature is advantageously fixed, but it may also be a variable radius of curvature, in particular increasing or decreasing along the curved profile,
a means of pivoting able to allow a rotation between the adapter and a connector outfitting the wiper blade is provided on the adapter, preferably wherein the transverse plane passes through the pivoting means. According to one embodiment, the first wall and the second wall carry this pivoting means, the linking wall being for example free of this. This pivoting means may be formed by a separate shaft traversing the adapter and the connector. It may also be strands made from the same material as the connector and oriented toward the outside of the latter. In such a case, the pivoting means of the adapter is formed by cavities able to receive these strands. The pivoting means may further be formed by two strands made from the same material as the adapter, and able to be lodged in one or more holes devised in the connector,
the adapter may be joined to a connector which is mounted able to move in rotation on the pivoting means,
the first wall and the second wall are parallel to the median longitudinal plane, and are planar in particular,
the linking wall extends at least directly above the pivoting means. The adapter may extend longitudinally between a first longitudinal end and a second longitudinal end, the linking wall extending between these two longitudinal ends. Alternatively, the adapter may extend longitudinally between a first longitudinal end and a second longitudinal end, the curved profile of the linking wall extending from the first longitudinal end to the second longitudinal end,
the adapter comprises, at a first longitudinal end, a terminal face whose profile has an inflection point. This terminal face extends in particular in a transverse plane, that is, one perpendicular to the median longitudinal plane,
the adapter comprises, at a first longitudinal end, a head provided with a median indentation. This indentation allows a positioning of the adapter on the wiper blade such that it covers an air deflector outfitting said blade,
the head is advantageously bounded by the terminal face, the latter having an S-profile, seen along an axis transverse to the adapter,
the adapter has a foot which is equipped with securing means in addition to a fixation of the adapter to the end portion,
the means of locking and/or unlocking has the form of a tongue equipped with a locking and/or unlocking button,
the tongue bends, or can bend, around an axis parallel to the median longitudinal plane,
the linking wall intersects the median longitudinal plane of the adapter,
the plane is orthogonal to the median longitudinal plane,
the linking wall is bounded by an external face and by an internal face, the external face having the curved profile while the internal face has a profile different from that of the external face. In such a case, the pro file of the internal face may be planar.
alternatively, the external face and the internal face may have a complementary, or identical profile,
the first length and the second length are measured along straight lines perpendicular to a plane passing through a free end of the first wall and a free end of the second wall,
the first wall is provided with a means of locking and/or unlocking the adapter on the end portion, this means possibly having the form of a button, for example, devised at the end of a tongue designed to bend and resume its position in the absence of force,
the first wall and the second wall are parallel to each other,
the adapter comprises, at a first longitudinal end, a head which is wider than a body of the adapter, said head being bounded by a flange having a curved profile seen in cross section along a plane transverse to the median longitudinal plane and passing through the head. In addition or alternatively, the head is taller than the body of the adapter, measured along the median longitudinal plane.

The invention also relates to a system of connection between a wiper blade and an end portion of a drive arm, comprising an adapter according to any one of the characteristics set forth in the present document, said adapter being mounted to pivot on a connector able to be integrated with the wiper blade. The integration of the connector with the wiper blade has no degree of freedom.

The invention further relates to an end portion of a drive arm equipped with an adapter according to any one of the characteristics set forth in the present document, or a connection system as mentioned above.

In similar fashion, the invention relates to an end portion of a drive arm, able to receive an adapter and comprising a first leg of a third length as well as a second leg of a fourth length, the third length being greater than the fourth length, as measured along straight lines parallel to a median longitudinal plane of the end portion, wherein one linking leg joins the first leg and the second leg and intersects the median longitudinal plane of the end portion, the first leg being provided with a slot able to lodge a means of locking and/or unlocking of the adapter.

The end portion advantageously comprises any one at least of the following characteristics, taken alone or in combination:
the linking leg is bounded by an external surface which is convex, seen from a position situated between the first leg and the second leg. Alternatively, the curved profile is convex, seen from a position situated between the first leg and the second leg,
the first leg is provided with a slot able to lodge a means of locking and/or unlocking of an adapter,
the end portion may be equipped with a pair of slides for attaching the end portion to the adapter, a length of the pair of slides being less than a length of the slot, measured in a longitudinal direction of the end portion,
the end portion may be bounded by a free longitudinal end whose one profile comprises at least one inflection point,
the linking leg intersects the median longitudinal plane of the end portion. The linking leg thus extends over more than one half-length of the end portion,
the end portion extends longitudinally between a first longitudinal end and a second longitudinal end, the curved profile of the linking leg extending from the first longitudinal end to the second longitudinal end,
the linking leg is bounded by an external surface and by an internal surface, the external surface and the internal surface each having a curved profile,
the first leg terminates in a third vertex, while the second leg terminates in a fourth vertex, the linking leg joining the third vertex and the fourth vertex,
the third length and the fourth length are measured along straight lines perpendicular to a plane passing through a longitudinal flange of the first leg and through a longitudinal flange of the second leg,
the end portion comprises at least one triangular profile seen along the transverse plane,
at least one curved profile of the linking leg runs along a radius of curvature between 5 mm and 100 mm, preferably between 7 mm and 30 mm, and for example 17.7 mm. Such a radius defines a virtual circle in whose periphery is inscribed the curvature of the external face,
the radius of curvature is advantageously fixed, but it may also be a variable radius of curvature, in particular increasing or decreasing along the curved profile,
the first leg and the second leg are parallel to each other,
the first leg and the second leg are parallel to the median longitudinal plane.

The invention also relates to a drive arm able to be equipped with a wiper blade, provided with an end portion as detailed in the present document.

The scope of the invention further encompasses a wiper blade equipped with a connector on which is mounted an adapter according to any one of the characteristics set forth in the present document. It will be noted that the adapter has a triangular or V-shaped section and that it overlaps the connector at least partly.

Finally, the invention relates to a wiping system comprising at least one wiper blade and a drive arm, both of them as detailed in the present document.

Advantageously, an internal surface of the linking leg of the end portion has a curved profile, while one linking wall of the adapter has a curved profile, the curved profile of the linking wall being complementary to the curved profile of the linking leg, this complementary relation pertaining in particular to the external face of the adapter and the internal surface of the end portion.

Thanks to all of these arrangements, the adapter is compact, sturdy, and has a minimal intake of air from an air flow circulating along the glass surface. Moreover, the button is easily accessible to a user who wishes to replace the wiper blade.

Other characteristics, details and advantages of the invention will emerge more clearly upon reading the following description, given as an illustration, in connection with the drawings in which:

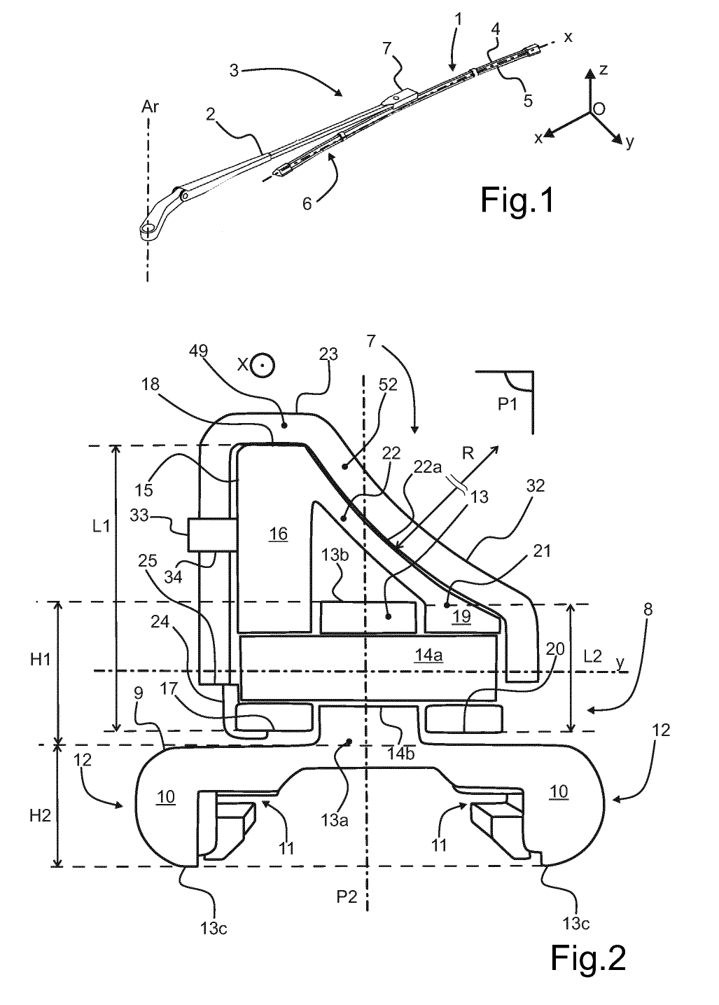

FIG. 1 is a perspective view of a wiping system according to the invention,

FIG. 2 is a cross section view of a connection system of the present invention, which is mounted between an end portion of a drive arm involved in the wiping system as illustrated in FIG. 1 and a wiper blade,

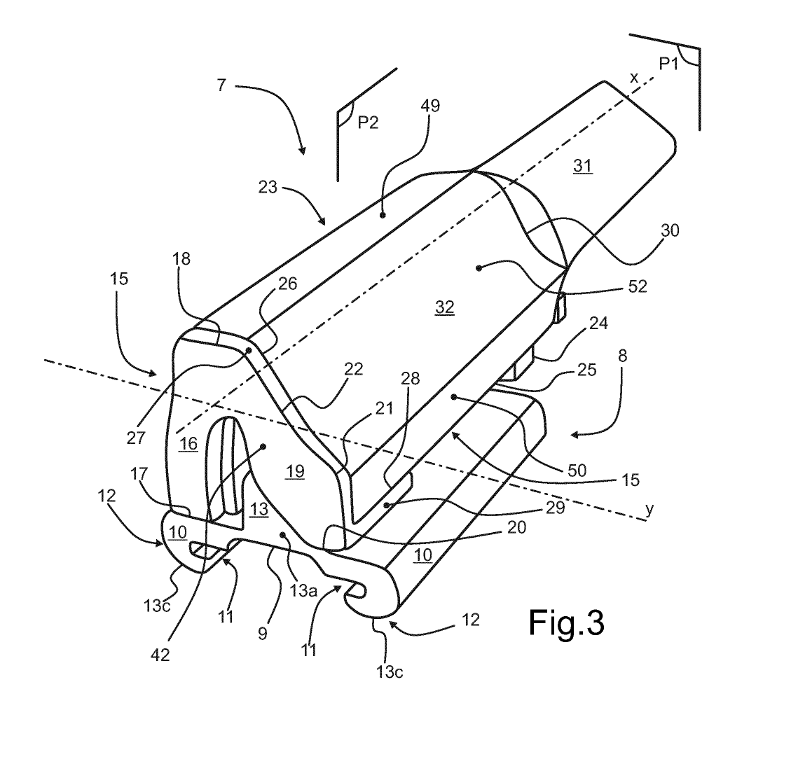

FIG. 3 is a perspective view of the connection system represented in FIG. 2,

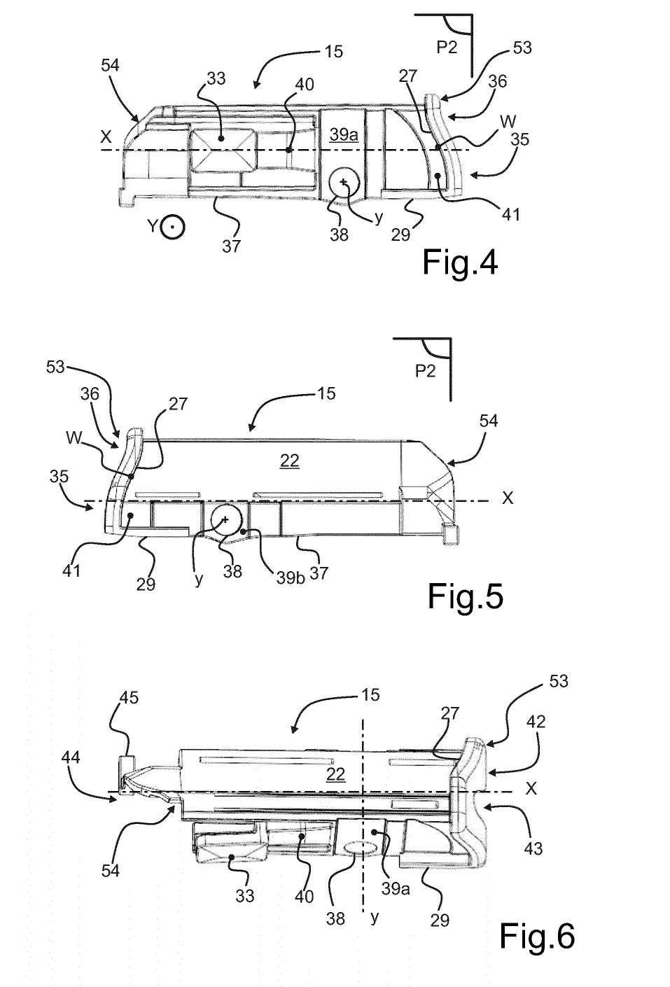

FIG. 4 is a view from a first side of an adapter of the present invention making up the connection system as illustrated in FIGS. 2 and 3,

FIG. 5 is a view from a second side of the adapter as illustrated in FIG. 4,

FIG. 6 is a top view of the adapter as illustrated in FIGS. 4 and 5,

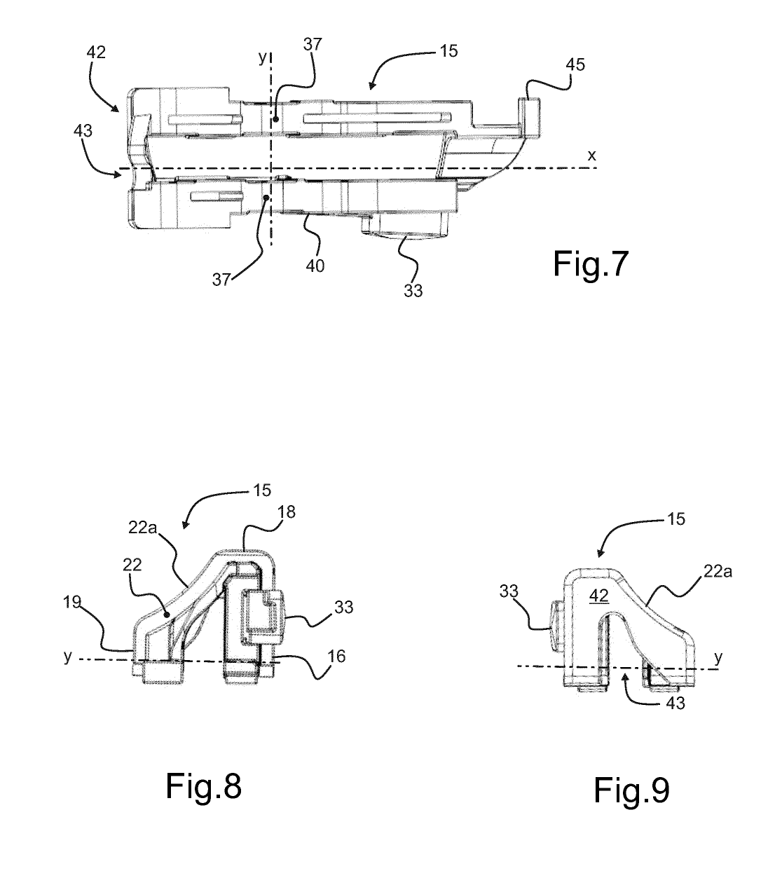

FIG. 7 is a bottom view of the adapter as illustrated in FIGS. 4 to 6,

FIG. 8 is a rear view of the adapter as illustrated in FIGS. 4 to 7,

FIG. 9 is a front view of the adapter as illustrated in FIGS. 4 to 8,

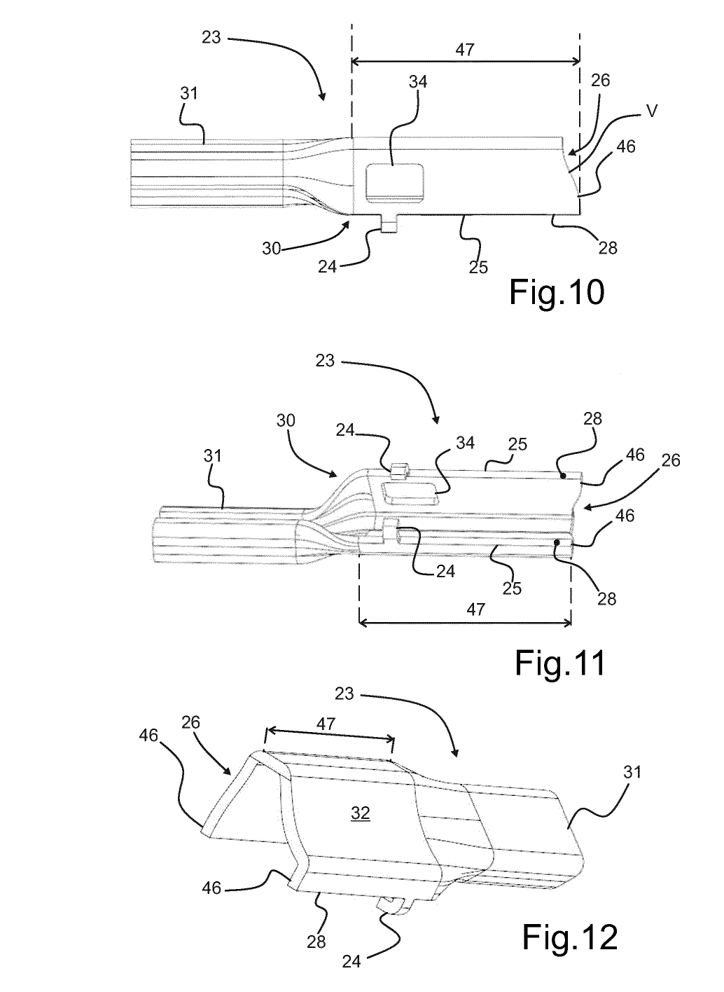

FIG. 10 is a side view of the end portion on which can be mounted the adapter as illustrated in FIGS. 4 to 9,

FIG. 11 is a bottom perspective view of the end portion as illustrated in FIG. 10,

FIG. 12 is a top and front perspective view of the end portion as illustrated in FIGS. 10 and 11,

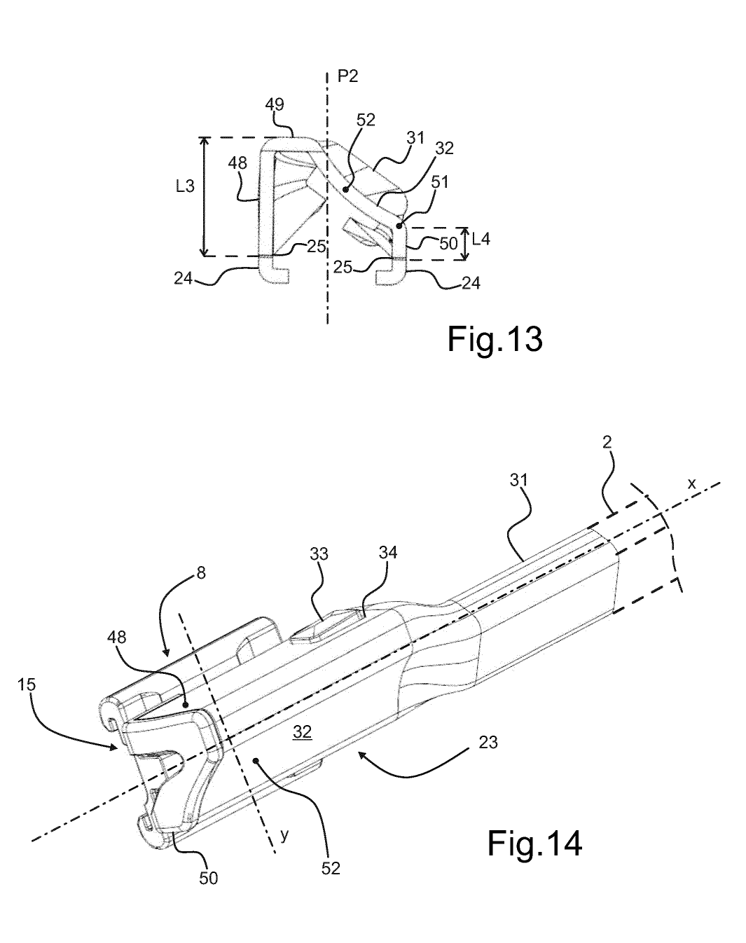

FIG. 13 is a front view of the end portion as represented in FIGS. 10 to 12,

FIG. 14 is a top perspective view of the end portion as illustrated in FIGS. 10 to 13, provided with the connection system as illustrated in FIGS. 2 and 3.

In the figures, the terms longitudinal, lateral, transverse, vertical, top, and bottom pertain to the orientation of a wiper blade 1 as illustrated in FIG. 1. A longitudinal direction corresponds to a longitudinal axis X along which the wiper blade 1 extends. This axis X likewise defines a longitudinal direction of the adapter of the invention. A transverse direction corresponds to that of a transverse axis Y which is perpendicular to the longitudinal axis X and to an axis of rotation Ar of a drive arm 2 making up a wiping system 3. A vertical direction, parallel to that of a vertical axis Z, and the terms upper and lower pertain to orientations parallel to the axis of rotation Ar of the drive arm 2 of the wiping system 3, the term lower containing the plane of the windscreen. For the longitudinal directions, the terms exterior and interior shall be viewed in relation to a pivoting point of the wiper blade 1 on a drive arm 2 of the wiper blade 1, the term interior corresponding to the portion where the drive arm 2 and a half-blade extend, and the term exterior corresponding to the portion where the other half-blade extends.

The directions mentioned above are illustrated in an orthonormal reference system Oxyz, represented in the figures. In this reference system, the axis Ox represents the longitudinal direction, the axis Oy represents the transverse direction, and the axis Oz represents the vertical direction.

In FIG. 1, a motor vehicle is commonly equipped with a wiping system 3 to evacuate water and/or grime present on a glass surface, especially a front windscreen of the motor vehicle. The wiping system 3 comprises the drive arm 2 able to effect an angular back and forth motion along and on top of the glass surface. The glass surface may be the front windscreen or a rear window of the motor vehicle.

The wiping system 3 also comprises the wiper blade 1 which extends along a principal axis, known as the longitudinal axis X parallel to the axis Ox. The wiper blade 1 comprises at least one air deflector 4 and a wiping strip 5. The air deflector 4 is designed to transform a pressure applied by a flow of air circulating along the glass surface in a force of the wiper blade 1 bearing against the glass surface of the motor vehicle. The wiping strip 5 is the piece of the wiper blade 1 in direct contact with the glass surface to evacuate the water and/or grime present on the latter. The air deflector 4 and the wiping strip 5 form a semi-rigid assembly 6 which is carried by a connection system 7, inserted between the drive arm 2 and the semi-rigid assembly 6.

The connection system 7 ensures a mechanical linkage between the drive arm 2 and the wiper blade 1 and thus makes it possible to separate the wiper blade 1 from the drive arm 2 for purposes of a replacement of the wiper blade 1.

In FIGS. 2 and 3, the connection system 7 comprises a connector 8 which is able to carry the wiper blade 1 and an adapter 15 on which is mounted the connector 8, able to move in rotation. These arrangements have the purpose, for example, of allowing the wiper blade 1 to follow a curvature of the windscreen during a back and forth movement of the wiper blade 1 as produced by the drive arm 2 along the glass surface of the motor vehicle. The adapter 15 is carried by an end portion 23 of the drive arm 2, the end portion 23 being either an end of the drive arm 2 itself or a piece attached to the drive arm 2 and whose end portion 23 constitutes the end.

According to one embodiment of the invention, the connector 8 and the adapter 15 are realized by moulding of a polymer material, such as a material from the family of the polyoxymethylenes, known as POM, or by moulding of a blend of polymer materials, such as a blend of polymers of the polycarbonate family and of the acrylonitrile butadiene styrene family, known as ABS. In the following description, it will be understood that the connector 8 and/or the adapter 15, and all their components, may each form a single piece, that is, a monobloc.

According to one embodiment, the end portion 23 is made by folding a metal sheet, such as a plate of steel or aluminium, or the like.

Referring more particularly to FIG. 2, the connector 8 comprises a base 9 which has at least two parallel rails 10 arranged along the longitudinal axis X and orthogonal to a transverse plane P1, which is parallel to the plane Oyz. Each rail 10 comprises a groove 11 which is arranged facing each other at equal distance from a median longitudinal plane P2, orthogonal to the transverse plane P1. More particularly, the grooves 11 are arranged facing each other to jointly form brackets 12 for holding structure elements of the wiper blade 1.

The median longitudinal plane P2 extends along the longitudinal axis X and passes through the centre of the adapter 15, or of the end portion 23, along the transverse axis Y. This centre may be determined based on a measurement taken between the external face either of walls making up the adapter or of legs making up the end portion.

The connector 8 also comprises a body 13 which overhangs the base 9 and which extends overall parallel to the median longitudinal plane P2. The body 13 is arranged in a longitudinal plate which is mounted movable in rotation on the adapter 15 essentially inside the median longitudinal plane P2. For this purpose, and according to the embodiment illustrated, the body 13 comprises at least one bearing 14b to receive a shaft 14a which passes through the adapter 15. The shaft 14a preferably extends along a transverse axis Y orthogonal to the longitudinal axis X and to the median longitudinal plane P2.

According to another embodiment, the body 13 may comprise two fingers respectively devised on each of its parallel lateral faces, the fingers fitting inside seats comprised by an internal surface of the adapter 15. According to yet another embodiment, the body 13 comprises two openings respectively devised in each of its parallel lateral faces, or a through hole, the openings or the hole receiving strands emerging from an internal surface of the adapter 15. According to the last two embodiments mentioned, the fingers on the one hand or the strands on the other hand are aligned with each other along the transverse axis Y to jointly form a means equivalent to the shaft 14a for rotation of the connector 8 with respect to the adapter 15, as illustrated in FIG. 2.

The body 13 of the connector 8 has a first height H1 situated between a base and a 13a and a distal end 13b of the body 13. The base 9 of the connector 8 has a second height H2 situated between the base 13a of the body 13 and a plane joining the proximal ends 13c of the base 9. The first height H1 and the second height H2 are situated inside the median longitudinal plane P2. The first height H1 is preferably between 1 and 1.2 times the second height H2. This results in a compact format for the connecter 8, such that the connection system 7 likewise has an advantageous compact nature.

The adapter 15 comprises a first wall 16 of a first length L1, situated between a first end and a first vertex 18. The adapter also comprises a second wall 19 of a second length L2, situated between a second end 20 and a second vertex 21. The first wall 16 and the second wall 19 are preferably planar. The first wall 16 and the second wall 19 are parallel to each other and parallel to the median longitudinal plane P2. The first length L1 is greater than the second length L2. For example, the first length L1 is greater than twice the second length L2.

The first vertex 18 and the second vertex 21 are joined to each other by a linking wall bounded by an external face 22a which is convex, seen by an observer looking at the external face 22a from the shaft 14a of rotation of the connector 8 on the adapter 15, or from a position lying between the first wall and the second wall 19 laterally bounding the adapter 15. The linking wall 22, or at least its external face 22a, is for example devised along a radius of curvature R which is greater than the first length L1. For example, the radius of curvature R is greater than twice the first length L1. As an example, the radius of curvature R is between 5 mm and 100 mm, preferably between 7 mm and 30 mm. In the example illustrated in the figures, the radius of curvature R is equal to 17.7 mm, which amounts to a good compromise between the air pressure on the adapter 15 via the end portion 23 and the space nevertheless needed to arrange the connector 8 and enable its rotation with respect to the adapter 15. Such a radius defines a virtual circle within whose periphery the curvature of the external face is inscribed.

The radius of curvature is advantageously fixed, but it may likewise be a variable radius of curvature, especially by increasing or decreasing along the curved profile. This radius of curvature defines the radius of a circle within whose perimeter is inscribed the external face 22a of the linking wall 22. It will be noted that this radius may be fixed, so that the curved profile forms a constant circular sector. Alternatively, the radius of curvature may vary, making it possible to open or close the curved profile. Finally, it will be noted that the radius of curvature may likewise vary along the longitudinal axis X of the adapter 15, of the end portion 23, between their first longitudinal end and their second longitudinal end.

The linking wall 22 is a wall intersecting the median longitudinal plane P2. It will be understood here that the linking wall 22 occupies a large portion of the transverse dimension of the adapter 15, that is, greater than 50% of its width as measured along the transverse axis Y. Thus, a section passing through the median longitudinal plane P2 cuts the linking wall 22. These arrangements are such that, along a section made in the transverse plane P1 and passing through the transverse axis Y, the adapter 15 has a triangular profile above a horizontal plane which passes through the second vertex 21 and which is orthogonal to the median longitudinal plane P2. This triangular profile is recognizable by observing the exterior wall of the adapter 15 in cross section, but optionally or alternatively by observing an internal volume of the adapter 15 bounded by an internal surface in cross section.

Likewise referring to FIG. 3, the end portion 23 of the drive arm 2 forms a shell which covers the first wall 16, the linking wall 22 and the second wall 19 of the adapter. More particularly, the end portion 23 overhangs the connection system 7 comprising the adapter and the connector 8. In other words, the geometrical characteristics of the end portion 23 which will be described below and especially the geometrical characteristics in cross section by the transverse plane P1 of the end portion 23 are valid for the entire end portion covering the connection system 7. The adapter 15 is received in the end portion 23 substantially by a movement of translation along the longitudinal axis X.

To facilitate the putting in place and/or holding of the adapter 15 in the end portion 23, the end portion 23 is in particular equipped with a pair of slides 24 to attach the end portion 23 to the adapter 15. The slides 24 are devised in particular on a respective longitudinal flange 25 of the end portion 23, which extends along the longitudinal axis X. The slides 24 are preferably disposed inside the transverse plane P1 and arranged facing each other. These two slides 24 are inwardly folded edges of the end portion 23, made of the same material as a first leg and as a second leg laterally bounding the end portion 23. These slides 24 form an element for guiding the adapter 15 in translation in the end portion 23 during a movement of putting the adapter 15 in place on the end portion 23.

The end portion 23 comprises one free longitudinal end, called the first longitudinal end 26, which is designed to make contact with an end face 27 of the adapter 15, at the end of the translatory movement described above. This end face 27 is devised at a first longitudinal end of the adapter 15. Likewise, the end portion 23 comprises a longitudinal edge 28 which is designed to make contact with a vertical end stop 29 of the adapter 15. The vertical end stop 29 and the longitudinal edge are devised in a horizontal plane which is orthogonal to the transverse plane P1 and to the median longitudinal plane P2. The vertical end stop 29 and the longitudinal edge 28 together form a means of vertical blocking of the adapter 15 and of the end portion 23 in combination with a particular profile of the end face 27, as described below.

The end portion 23 comprises a second longitudinal end 30 which is opposite the first longitudinal end 26 and which is integrated with a sleeve 31 outfitting the drive arm 2 and/or made from the drive arm 2. Between the first longitudinal end 26 and the second longitudinal end 30, the end portion 23 has an external surface 32 which is convex and which may be devised with the same radius of curvature R as the external face 22a of the linking wall 22, mentioned above. In such a case, the external surface 32 is geometrically similar to the conformation of the external face 22a of the linking wall 22. More particularly, the external surface 32 is identical in conformation to that of the linking wall 22. Of course, the radius of curvature of the external surface 23 may likewise be different from the radius of curvature of the external face 22a. The convex shape of the external surface 32 is understood to be seen from the interior of the end portion 23, that is, from a position situated between the legs defining the end portion 23. The arrangements defining the different embodiments of the radius of curvature of the linking wall 22 as described above apply mutatis mutandis to the radius of curvature defining the end portion 23.

Referring once more to FIG. 2, the first wall 16 is equipped with a means 33 of locking and/or unlocking the adapter 15 in the end portion 23. According to the example illustrated, the means of locking and/or unlocking is a button 33 which is retractable and which can be moved under manual pressure. In the locking position, as represented in FIG. 2, the button 33 emerges through a slot devised in the end portion 23, such that a pressure applied by a user to the button 33 allows the button 33 to be disengaged from the slot 34 to release the adapter 15 from the end portion 23. In other words, the button 23 is retractable between a locking position in which the button 33 is lodged inside the slot 34 and an unlocking position in which the button 33 is positioned outside the slot 34.

In FIGS. 4 and 5, the end face 27 of the adapter 15 has a profile comprising an inflection point W. In other words, the end face 27 has a lower zone 35 which emerges, along the longitudinal axis X of the adapter 15, with respect to an upper zone 36 which likewise comprises the end face 27. Put yet another way, the lower zone 35 of the end face 27 forms a longitudinal bulging of the adapter and constitutes a protruding longitudinal end of the latter. Such an S-shaped profile of the end face 27, seen from the side, allows a lower portion 46 of the first longitudinal end 26 of the end portion 23 to be lodged inside the lower zone 35, which immobilizes the adapter 15 on the end portion 23 and prevents a vertical breakaway of the latter. This is achieved thanks to complementary shapes of the S profile of the end face 27 and an S profile of the first longitudinal end 26, as will be described further below.

These arrangements are such that the lower zone 35 participates in means of fixation 24, of the adapter 15 in the end portion 23, these means of fixation 24, 35 likewise comprising the slides 24 described above, which make contact with the lower edges 37 of the adapter 15. In other words, a fixation of the adapter 15 in the end portion 23 is achieved by making contact between the slides 24 of the end portion 23 and the lower edges 37 of the adapter 15 and by fitting the lower portion 46 of the first longitudinal end 26 of the end portion 23 inside the lower zone 35 of the end face 27 of the adapter 15.

FIG. 5 likewise shows that the linking wall 22 is situated at least above and straight above the pivoting means of the adapter 15, formed here for example by the holes 38. This linking wall extends in particular longitudinally between the first longitudinal end 53 and a second longitudinal end 54 bounding the adapter 15 along the longitudinal axis X. This wall thus extends for the entire length of the adapter 15.

The adapter 15 comprises for example two openings 38 to hold the shaft 14a, the openings being devised in two longitudinal portions 39a, 39b opposite each other with respect to the median longitudinal plane P2. These openings 38 form here an exemplary embodiment of the pivoting means outfitting the adapter 15. A first longitudinal portion 39a emerging from the first wall 16 is provided with a tongue 40 which is equipped with the button 33 for locking and/or unlocking the adapter 15 in the end portion 23. The tongue 40 and the button 33 are aligned along the longitudinal axis X. The tongue 40 is mounted to rock on the first longitudinal portion 39a such that the button 33 in a first part of its rocking motion is essentially movable along the transverse axis Y. The tongue 40 is thus articulated in rotation about an axis which is parallel and offset with respect to the median longitudinal plane P2. This axis of articulation passes through the first wall 16. Preferably, the button 33 is a button having a planar bearing face and formed primarily from an element hollowed out opposite its bearing face.

In FIGS. 6 to 9, the end face 27 is arranged on a head 42 of the adapter 15 having a profile geometrically similar to the profile of the end face 27. In other words, the head 42 comprises a lower base which is protruding with respect to an upper vertex. The head 42 likewise comprises a median indentation 43 to allow a passage of the wiper blade 1, particularly its air deflector. Opposite the head 42, the adapter 15 comprises a foot 44 which is equipped with securing means 45, composed of at least one transverse end stop, and preferably a single transverse end stop. The transverse end stop extends preferably along an axis parallel to the transverse axis Y. These securing means 45 are meant to hold in place the wiper blade 1 on the drive arm 2 in event of breakage of the means 33 of locking and/or unlocking. The head 42 bounded at least by the end face 27 forms in particular a flange emerging transversely and vertically beyond an external wall 41 of the adapter 15.

In FIGS. 10 to 13, the end portion 23 comprises a juncture zone 47 lying between the first longitudinal end 26 and the second longitudinal end 30 and designed to receive and cover the adapter 15. FIG. 10 illustrates the shape of the free end 26 of the end portion 23, being complementary to the S profile of the end face 27 of the adapter 15. Thus, seen from the side, the profile of the free end 26 has at least one inflection point V, such that this profile forms an S.

In FIG. 13, the juncture zone 47 comprises a first leg 48 of a third length L3, measured between the longitudinal flange 25 and a third vertex 49, along a straight line parallel to the median longitudinal plane P2 of the end portion 23. The juncture zone 47 also comprises a second leg 50 of a fourth length L4, measured between the longitudinal flange 25 and a fourth vertex 51, along a straight line parallel to the median longitudinal plane P2 of the end portion 23.

The first leg 48 and the second leg 50 are preferably planar. The first leg 48 and the second leg 50 are parallel to each other and parallel to the median longitudinal plane P2. The third length L3 is greater than the fourth length L4. The third length L3 is for example greater than twice the fourth length L4. It will be noted at this point in the description that, in a cross section produced in the transverse plane P1, the end portion 23 has a triangular profile, for example, of the same type as that of the adapter 15 described above. Thus, the third vertex 49 and the fourth vertex are joined together by a linking leg 52 comprising the external surface 32 which is convex to an observer looking at the end portion 23 from a point situated between the first leg 48 and the second leg 50. The linking leg 52 advantageously hugs the shape of the linking wall 22, the two being in tight contact, to ensure an optimized compactness and a better rigidity and solidity of the connection system 7. Thus, the linking leg 52 forms a bearing, or force absorbing wall of the linking wall 22 when a user pinches the connection system 7 and the end portion 23 to press against the means 33 of locking and/or unlocking, as described below.

It will be noted that the triangular profile of the end portion 23 is recognizable by observing in cross section an exterior surface of the end portion 23, but optionally or alternatively by observing in cross section an internal volume of this end portion 23 bounded by an internal surface. According to the embodiment illustrated, the third vertex 49 forms a plateau extending in a plane perpendicular to the plane of the first leg 48. This plateau then joins the first leg 48 directly to the linking leg 52.

Referring to FIG. 14, which represents the end portion 23 holding the adapter 15 carrying the connector 8, one will note the compactness of the assembly formed by these elements, as well as the opposite arrangement of the first leg 48 provided with the slot 34 through which emerges the means 33 of locking and/or unlocking and the linking leg 52 whose external surface 32 is convex, seen for example from the adapter 15. These arrangements offer an aerodynamic profile suited to this assembly in order to prevent a lifting of the wiper blade 3 from the glass surface of the motor vehicle, while affording an ergonomical locking and unlocking of the adapter 15 with respect to the end portion 23, based on the presence of the button 33 emerging opposite the external surface 32, which latter may advantageously serve as the bearing surface for a finger of a user in opposition to another finger of the user which bears against the button 33.

1. An adapter for connecting a wiper blade to an end portion of a drive arm, comprising:
a first wall; and
a second wall,
the first wall and the second wall being interconnected by at least one linking wall,
wherein the linking wall intersects a median longitudinal plane of the adapter,
wherein the first wall has a first length which is greater than a second length of the second wall, the first length and the second length being measured along straight lines parallel to the median longitudinal plane, and
wherein the first wall is provided with at least one means of locking and/or unlocking the adapter on the end portion.

2. The adapter according to claim 1, wherein the first wall terminates in a first vertex, while the second wall terminates in a second vertex, the linking wall joining the first vertex and the second vertex.

3. The adapter according to claim 1, further comprising at least one triangular profile, seen in a transverse plane.

4. The adapter according to claim 1, wherein the linking wall comprises an external face which is convex, seen from a position located between the first wall and the second wall.

5. The adapter according to claim 4, wherein the external convex face has a radius of curvature between 7 mm and 30 mm.

6. The adapter according to claim 1, having a means of pivoting able to allow a rotation between the adapter and a connector outfitting the wiper blade.

7. The adapter according to claim 1, wherein the first wall and the second wall are parallel to the median longitudinal plane.

8. The adapter according to claim 1, extending longitudinally between a first longitudinal end and a second longitudinal end, the linking wall extending from the first longitudinal end to the second longitudinal end.

9. The adapter according to claim 1, further comprising, at a first longitudinal end, a terminal face whose profile has at least one inflection point.

10. The adapter according to claim 9, further comprising, at a first longitudinal end, a head which is larger than a body of the adapter and provided with an indentation.

11. The adapter according to claim 10, wherein the head is bounded by the terminal face, the latter having an S-profile.

12. The adapter according to claim 1, wherein the means of locking and/or unlocking has the form of a tongue equipped with a locking and/or unlocking button.

13. The adapter according to claim 12, wherein the tongue bends around an axis parallel to the median longitudinal plane.

14. A system of connection between a wiper blade and an end portion of a drive arm, comprising: an adapter as claimed in claim 1, being mounted to pivot on a connector able to be integrated with the wiper blade.

15. An end portion of a drive arm equipped with an adapter according to claim 1.

16. The end portion of a drive arm that receives an adapter the end portion comprising:
a first leg of a third length; and
a second leg of a fourth length,
the third length being greater than the fourth length, as measured along straight lines parallel to a median longitudinal plane of the end portion,
wherein one linking leg joins the first leg and the second leg and intersects the median longitudinal plane of the end portion, the first leg being provided with a slot able to lodge a means of locking and/or unlocking of the adapter.

17. The end portion according to claim 16, wherein the linking leg is bounded by an external surface which is convex, seen from a position situated between the first leg and the second leg.

18. The end portion according to claim 16, wherein the end portion is equipped with a pair of slides for attaching the end portion to the adapter, a length of the pair of slides being less than a length of the slot.

19. The end portion according to claim 16, bounded by a free longitudinal end whose one profile comprises at least one inflection point.

20. A drive arm able to be equipped with a wiper blade, provided with an end portion according to claim 16.

21. A wiper blade equipped with a connector on which is mounted an adapter according to claim 1.

22. A wiping system comprising: at least one wiper blade according to claim 21; and a drive arm provided with an end portion comprising a first leg of a third length and a second leg of a fourth length, the third length being greater than the fourth length, as measured along straight lines parallel to a median longitudinal plane of the end portion, wherein one linking leg joins the first leg and the second leg and intersects the median longitudinal plane of the end portion, the first leg being provided with a slot able to lodge a means of locking and/or unlocking of the adapter.
